(19) United States
(12) Patent Application Publication
(10) Pub. No.: US 2009/0242384 A1
(43) Pub. Date: Oct. 1, 2009

(54) Low Pressure Mixing System for Desalting Hydrocarbons

(76) Inventors: Robert A. Curcio, Cypress, TX (US); Ronald D. Hypes, Houston, TX (US); Davis L. Taggart, Tulsa, OK (US); Michael R. Brown, Tulsa, OK (US); S. Pavankumar B. Mandewalkar, Tulsa, OK (US); Gary W. Sams, Tulsa, OK (US)

Correspondence Address: GABLE & GOTWALS, 100 WEST FIFTH STREET, 10TH FLOOR, TULSA, OK, 74103, US

(21) Appl. No.: 12/411,114

(22) Filed: Mar. 25, 2009

Related U.S. Application Data
(60) Provisional application No. 61/039,897, filed on Mar. 27, 2008.

(51) Int. Cl. B01J 19/08

(52) U.S. Cl. 204/168; 422/186.04

(57) ABSTRACT

A method and system for reducing the salt content of a crude oil stream includes using a quill to disperse a water stream into the crude oil and then routing the mixed oil/water stream through a plurality of mixing stages. The water stream may include a wash water that has been preconditioned with recycled effluent water. Each mixing stage increases the homogeneity of the mixed oil/water stream. The first and third mixing stages are preferably lower pressure stages relative to the second mixing stage, which provides pressure effective for flowing the mixed oil/water stream through the third and fourth mixing stages. Upon exiting the fourth mixing stage, the mixed oil/water stream is electrostatically treated in a dual frequency separator vessel or a dual polarity separator vessel.

### CROSS-REFERENCE

This application claims priority to, and the benefit of, U.S. Provisional Patent Application No. 61/039,897, filed on Mar. 27, 2008.

### BACKGROUND OF THE INVENTION

The typical process for desalting crude oil involves mixing fresh water into a crude oil stream and taking a pressure drop across a mixing valve. In this way the fresh water “washes” the salt out of the oil. Once the oil and water are mixed, the water is extracted from the oil by flowing the mixture through an electrostatic dehydrator. To avoid creating an emulsion that an electrostatic field cannot process, the pressure drop across the mixing valve is typically limited to less than 15 psi.

As production and processing techniques for crude oil have evolved, it has become common for the techniques to create salt crystals in the crude oil. Because these crystals cannot be removed directly by the electrostatic process, the crystals must first be dissolved or wetted by the fresh water. However, the crystals are difficult to dissolve because they are oil-coated. Use of pressure drops higher than 15 psi, therefore, is required to dissolve the salt out of the oil prior to extraction by the electrostatic field.

A second, more common problem occurs in refineries where salt levels must be reduced to very low levels in order to avoid corrosion and catalyst fouling. Although the oil arriving at a refinery has been previously processed by a production company to meet a refinery acceptance specification, residual water containing salt remains as a very fine dispersion and is very difficult to remove. These oils, therefore, also benefit from a higher pressure drop mix system.

Last, taking a higher pressure drop across the mixing valve imposes a higher back pressure on a crude charge pump. This back pressure reduces the capacity of the pump, thereby affecting the crude charge rate. A high pressure mix system, therefore, is needed to achieve mixing requirements but the system must be designed to overcome its own pressure drop to avoid any reduction in crude charge rate.

As shown in Table 1, tests of a crude containing crystalline salt revealed that pressure drops higher than 45 psi can be required to meet a salt limit of 1 ptb (pounds of salt per thousand barrels). Assuming no crystalline salt present in a typical crude oil, and using one stage of mixing—equating to a pressure drop of 15 psi—a 0.3% BSW content in the crude should result in a salt level of 1 ptb. Testing has determined that three mixing stages, equating to a pressure drop of 45 psi, and passing the crude oil through a dual polarity electrostatic field failed to meet the 1 ptb level. Higher mix energy required a more aggressive electrostatic dehydration technology, such as a dual frequency process. Dual frequency is a new electrostatic technology; dual polarity is an older technology. The dual frequency process coupled to a three-stage mix system easily met the salt limit, thus showing the superiority of using the dual frequency process. The data support a finding that higher mixer energy is required to dissolve salt crystals but at the same time it creates an emulsion that is more difficult to resolve. This test suggests that some portion of the mix energy can be provided by a pump.

TABLE 1

| Mix | Electrostatic | Desalted Oil NaCl | |
|---|---|---|---|
| Technology | Technology | (ptb) | Comments |
| 1 stage | Dual polarity | ≦1 | No crystalline salt |
| 3 stage | Dual polarity | ≦3 | Up to 15 ptb of |
| | | | crystalline salt |
| 3 stage | Dual frequency | ≦1 | Up to 15 ptb of |
| | | | crystalline salt |
| Mechanical | Dual frequency | ≦1 | Up to 15 ptb of |
| | | | crystalline salt |

### BRIEF SUMMARY OF THE INVENTION

A method and system for reducing the salt content of a crude oil stream includes using a quill to disperse a fresh water stream into the crude oil stream and then routing the mixed oil/water stream through four mixing stages. Each mixing stage increases the homogeneity of the mixed oil/water stream. The first mixing stage produces the only backpressure the crude charge pump needs to overcome. Upon exiting the fourth stage, the mixed oil/water stream is electrostatically treated in a separator vessel. The separator vessel may be a dual frequency separator vessel or a dual polarity separator vessel (desalter). The desalted oil is removed from an upper portion of the vessel and the effluent water is extracted from a lower portion of the vessel.

The first and third mixing stages include static mixers and are lower pressure mixing stages relative to the second mixing stage. The pressure drop across the first and third mixing stages may be in the range of 3 to 5 psi. The second mixing stage provides a pressure increase effective for flowing the mixed oil/water stream through the third and fourth mixing stages. This second stage preferably includes a boost pump and provides a pressure increase of about 25 psi. The fourth mixing stage includes a mixing valve and is capable of providing higher mix energy than the third stage. The pressure drop across the valve may be in the range of 5 to 20 psi. Depending on desalting requirements, one or more four-stage mixing systems and separator vessels in series may be required. Similarly, the first and second mixing stages may be bypassed.

The water stream may include a wash water that has been preconditioned with an effluent water. The effluent water that is extracted from the separator vessel may be recycled and used in the preconditioning step. A static mixer may be used to precondition the wash water by mixing the wash water with the effluent water. A portion of the recycled effluent water may also be routed to a second four-stage mixing system and separator vessel.

A better understanding of the method and system will be obtained from the following detailed description of the preferred embodiments taken in conjunction with the drawings and the attached claims.

### BRIEF DESCRIPTION OF THE DRAWINGS

FIG. 1 is a diagram of a mix system that includes a water mixer, a water injection quill, a boost pump, two oil/water mixers positioned upstream and downstream of the boost pump, and a mix valve.

FIG. 2 is a diagram of a two stage desalting process. A first mix system of FIG. 1, represented by the first dashed outline and including the mix valve, is positioned ahead of the first separator vessel. A second mix system of FIG. 1, represented by the second dashed outline and including the wash water and mix valve, is positioned ahead of the second separator vessel.

FIG. 3 is a diagram of a single stage desalting process employing a single mix system. The mix system is represented by the dashed outline including the wash water and mix valve.

FIG. 4 is an arrangement of a piping system configured for connecting the various components of the mix system. Pressure gauges, isolation valves and bypass piping are provided.

### DETAILED DESCRIPTION OF THE PREFERRED EMBODIMENTS

The invention described below is not limited in its application to the details illustrated in the accompanying drawings. The invention is capable of other embodiments and of being practiced or carried out in a variety of ways. The phraseology and terminology employed herein are for purposes of description and not limitation. Elements illustrated in the drawings are identified by the following numbers:

10 Oil/water mix system

12 Crude charge pump

16 Heat Exchanger

18 Quill

20 Wash water

22 Recycled water

24 Water static mixer

26 Isolation valve

28 Oil/water static mixer

30 Pressure gauge

32 Bypass valve

34 Pressure gauge

36 API boost pump

38 Oil/water static mixer

40 Isolation valve

42 Pressure gauge

46 Mix valve

48 Separator vessel

50 Isolation valve

52 Isolation valve

58 Separator vessel

62 Recycle pump

64 Bypass piping

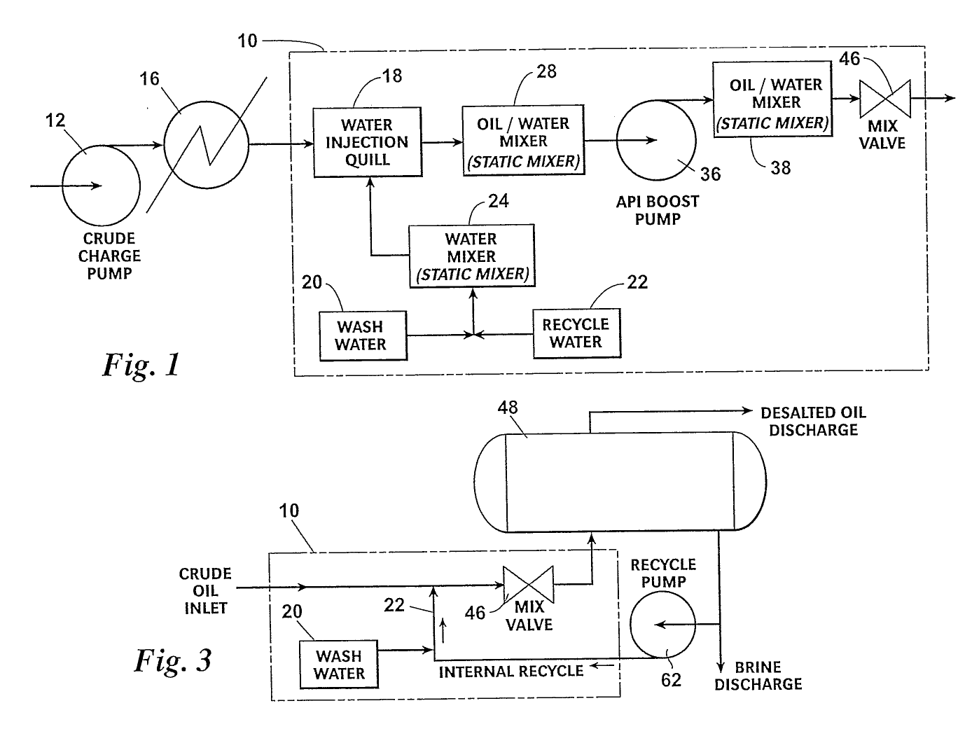

Referring to the drawings and first to FIG. 1, an oil/water mix system 10 includes a boost pump 36, static mixers 24, 28, and 38, and a mix valve 46. A crude charge pump 12 supplies a crude oil stream that flows through a heat exchanger 16 at a predetermined rate and into a water injection quill 18. Quill 18 is of a type well-known in the art for dispersing water into the crude. A primary function of quill 18 is to disperse water received from a water mixer 24 into the center of the crude stream for maximum mixing effect.

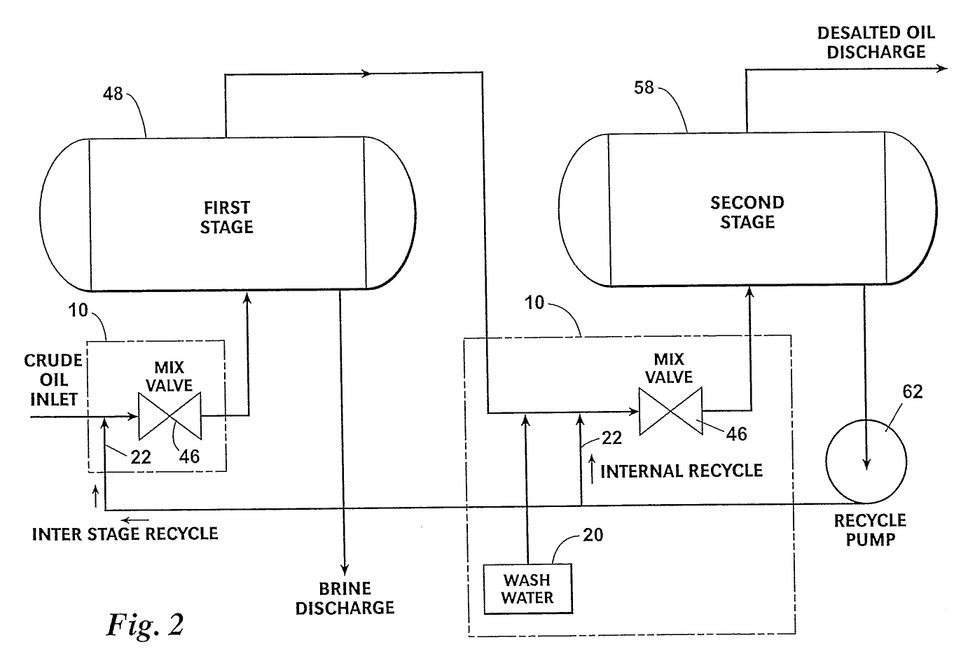

Water mixer 24 mixes recycled water 22 with wash water 20 prior to waters 20, 22 being injected into the crude stream. Water mixer 24 is preferably configured so that a substantially homogeneous water stream is produced. Recycled water 22 is preferably drawn from a bottom portion of a desalting vessel (see FIG. 2). If the recycled water 22 is of a very low salinity, it can be used effectively to extract and dilute additional salt in the crude stream. Wash water 20 is preferably fresh water which may come from any number of sources.

Because wash water 20 is fresh water, it fails to disperse as rapidly in crude and contact the crystallized salt as does recycled water 22. Recycled water 22 may disperse more readily because it has been previously contacted by the crude, making it more compatible with the crude. Mixing the two water sources 20, 22 in mixer 24 prior to injection has the advantage of pre-conditioning the wash water 20, making wash water 20 easier to disperse into the crude and contact the crystalline salt. A wetting agent may be added to wash water 20 to improve the efficiency of droplet-crystal contact. The pressure drop across mixer 24 is preferably in a range of 3 to 5 psi.

The water stream exiting water mixer 24 is routed through injection quill 18 to oil/water mixer 28. Mixer 28 is of a type well-known in the art and preferably comprises several short stationary vanes arranged in series. Each vane rotates the oil/water emulsion stream 90 degrees and subsequent vanes are set at a 90 degree angle to split the flow of the stream. Mixer 28 provides a first stage of mixing to increase homogeneity of the oil/water emulsion. The pressure drop across mixer 28 is preferably in a range of 3 to 5 psi. This pressure drop represents the only pressure drop that crude charge pump 12 must overcome.

The oil/water emulsion stream exiting mixer 28 is routed to a centrifugal boost pump 36. Pump 36 is of a type well-known in the art and typically used to increase pressure in a pipeline. Pump 36 is preferably a variable frequency drive pump and the differential pressure across pump 36 is preferably about 25 psi. Pump 36 provides two primary functions for mix system 10. First, pump 36 provides a second stage of mixing between the crude oil and the substantially homogenous mix of waters 20, 22. To avoid excessive shearing, pump 36 is a closed impeller type pump, but because pump 36 is mixing as well as pumping an open impeller might prove better in certain applications. Second, pump 36 increases pressure of the flowing oil/water emulsion. This increase in pressure pushes the emulsion to pass through a second mixer 38 and into a mix valve 46. Mixer 38, which is preferably similar to mixer 28, further homogenizes the oil/water emulsion. Mixer 38 is required in case pump 36 should promote centrifugal separation of the waters 20, 22 from the crude oil. Mixer 38 represents a third stage of mixing.

The oil/water emulsion exiting from mixer 38 is routed to mix valve 46. Mix valve 46 is of a type well-known in the art and typically is a single or double port globe valve or a ball valve. The style of valve used is not critical to the process but preferably mix valve 46 is suitable for creating pressure drops ranging from 5 to 20 psi. Mix valve 46 represents a fourth and final stage of mixing.

Referring now to FIG. 2, mix system 10 as described above may be used ahead of each stage in a two-stage desalting process. A first stage includes a separator vessel 48 in communication with mix valve 46. Separator vessel 48 is of a type well-known in the art and preferably employs an electrostatic process. In testing the system of this invention, a National Tank Company DUAL POLARITY® treater has been used as separator vessel 48. Because wash water is not always used in the first stage, a first stage water mixer 24 may be eliminated or isolated from mix system 10. A recycle pump 62 provides recycled water 22 drawn from a bottom portion of a second separator vessel 58. Brine extracted from a bottom portion of vessel 48 may be sent to a discharge sewer. Crude extracted from a top portion of vessel 48 is then routed to second mix system 10 positioned ahead of second stage vessel 58.

The second stage includes a separator vessel 58 in communication with a second mix valve 46. Separator vessel 58 is preferably similar to vessel 48. Because the second stage typically uses wash water 20 and recycled water 22, water mixer 24 (not shown) is included in the second mix system 10. Desalted oil is then discharged from a top portion of vessel 58.

Referring now to FIG. 3, mix system 10 may also be used ahead of a single stage desalting process. A recycle pump 62 provides recycled water 22 drawn from a bottom portion of separator vessel 48. Because wash water 20 is also provided, mix system 10 preferably includes a water mixer 24. Desalted oil is discharged from a top portion of vessel 48. Vessel 48 preferably includes a dual frequency electrostatic process such as the National Tank Company DUAL FREQUENCY® electrostatic process.

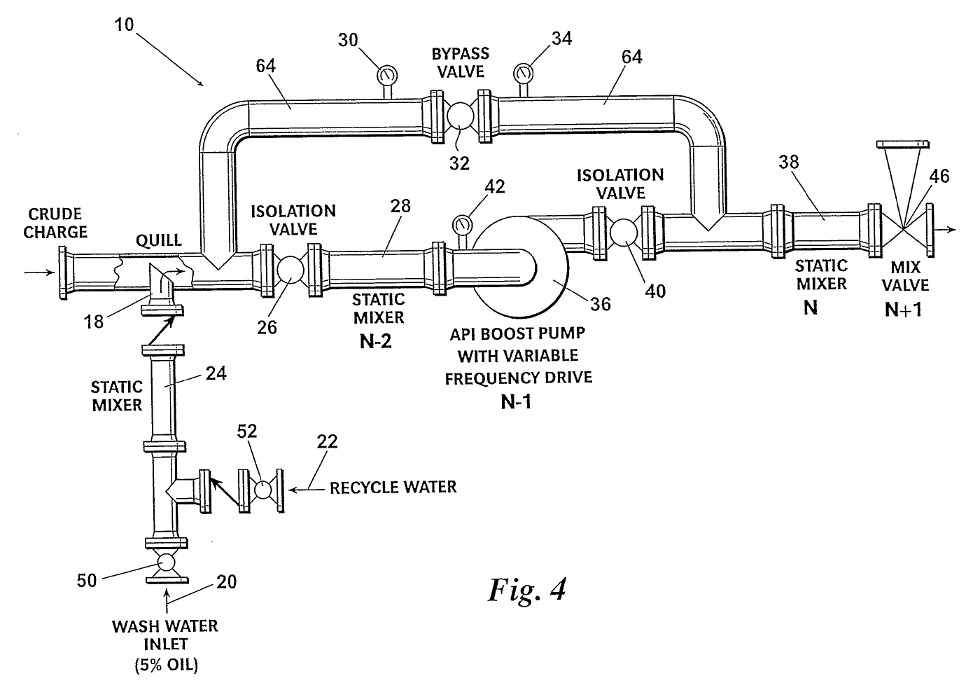

Referring now to FIG. 4, a set of isolation valves 26, 40 may be provided to isolate the first oil/water mixer 28 and pump 36 from the oil/water emulsion exiting quill 18. The oil/water emulsion then flows through a bypass piping 64 and into the second oil/water mixer 38. Flow of the oil/water emulsion is controlled by a bypass valve 32. Pressure gauges 30, 34 monitor the pressure within the bypass piping 64 upstream and downstream of bypass valve 32. A pressure gauge 42 monitors the pressure at pump 36. Additionally, isolation valves 50 and 52 may be provided to isolate wash water 20 and recycled water 22, respectively, from mixer 24.

The foregoing description details certain preferred embodiments of the present invention and describes the best mode contemplated. It will be appreciated, however, that changes may be made in the details of construction and the configuration of components without departing from the spirit and scope of the disclosure. Therefore, the description provided herein is to be considered exemplary, rather than limiting, and the true scope of the invention is that defined by the following claims and the full range of equivalency to which each element thereof is entitled.

What is claimed is:

1. A method for use in reducing a salt content of a crude oil stream comprising the steps of:
dispersing a water stream into the crude oil stream to produce a mixed oil/water stream;
routing the mixed oil/water stream through a plurality of mixing stages to increase the homogeneity of the mixed oil/water stream;
routing the mixed oil/water stream to a separator vessel whereby at least a substantial portion of said salt content is absorbed by water in said mixed stream;
electrostatically treating said mixed oil/water stream in said separator vessel;
extracting water from a lower portion of said separator vessel; and
extracting treated oil from an upper portion of said separator vessel.

2. A method according to claim 1 wherein at least one of said mixing stages has a pressure differential in a range of 3 to 5 psi.

3. A method according to claim 1 wherein at least one of said mixing stages has a pressure differential of about 25 psi.

4. A method according to claim 1 wherein said mixing stages includes a boost pump.

5. A method according to claim 1 wherein one of said mixing stages has a pressure differential in a range of 5 to 20 psi.

6. A method according to claim 1 including the step of preconditioning said water stream with an effluent water stream.

7. A method according to claim 1 including the step of recycling a portion of the water extracted from said separator vessel into said water stream to produce said mixed oil/water stream.

8. A method according to claim 1 wherein said plurality of mixing stages includes a first, second, third and fourth mixing stage and wherein each mixing stage increases the homogeneity of said mixed oil/water stream.

9. A method according to claim 1 wherein said step of electrostatically treating said mixed oil/water stream in said separator vessel uses a separation vessel selected from a dual polarity electrostatic separator vessel and a dual frequency electrostatic separator vessel.

10. A method according to claim 1 further comprising the step of adding a wetting agent to the water stream.

11. A system for desalting hydrocarbons comprising:
a crude oil stream;
a water stream;
a quill;
a first, second, third and fourth mixing stage;
a separator vessel located downstream of said fourth mixing stage;
said separator vessel being selected from the group consisting of a dual frequency electrostatic separator vessel and a dual polarity electrostatic separator vessel;
each said mixing stage being effective for increasing the homogeneity of a mixed oil/water stream;
said first and third mixing stages including a static mixer and each being a lower pressure mixing stage relative to the second mixing stage;
said second mixing stage providing a pressure increase effective for flowing the mixed oil/water stream through the third and fourth mixing stages;
said fourth mixing stage including a mixing valve and being capable of providing increased mix energy relative to said third mixing stage.

12. A system according to claim 11 further comprising the water stream including a wash water and an effluent water.

13. A system according to claim 12 further comprising a water mixing stage including a static mixer.

14. A system according to claim 11 further comprising at least one of said first and third mixing stages having a pressure differential in a range of 3 to 5 psi.

15. A system according to claim 11 further comprising said second mixing stage including a boost pump.

16. A system according to claim 11 further comprising said second mixing stage having a pressure differential of about 25 psi.

17. A system according to claim 11 further comprising said fourth mixing stage having a pressure differential in a range of 5 to 20 psi.

18. A system according to claim 11 further comprising a bypass piping for bypassing said first and second mixing stages.

19. A system according to claim 11 further comprising the water stream including a wetting agent.
